(19) United States
(12) Patent Application Publication
(10) Pub. No.: US 2021/0206899 A1
(43) Pub. Date: Jul. 8, 2021

(54) SYNTHESIS OF JANUS DENDRIMERS

(71) Applicants: Faezeh Najafi, Birjand (IR); Mehdi Salami-Kalajahi, Tabriz (IR); Hossein Roghani-Mamaqani, Tabriz (IR)

(72) Inventors: Faezeh Najafi, Birjand (IR); Mehdi Salami-Kalajahi, Tabriz (IR); Hossein Roghani-Mamaqani, Tabriz (IR)

(73) Assignee: Sahand University of Technology, Tabriz (IR)

(21) Appl. No.: 17/206,170

(22) Filed: Mar. 19, 2021

Related U.S. Application Data
(60) Provisional application No. 63/077,712, filed on Sep. 14, 2020.

(51) Int. Cl. C08F 293/00

(52) U.S. Cl. CPC C08F 293/00

(57) ABSTRACT

A method for synthesizing Janus dendrimers, including synthesizing a hydrophobized dendrimer by reacting a dendrimer with a carboxylic acid, forming a first dendron with a thiol group by splitting the hydrophobized dendrimer through breaking a disulfide bond of the core into thiol groups, forming a reactive dendron by reacting the thiol group of the first dendron with methyl acrylate and a radical initiator, synthesizing a primary core by reacting the reactive dendron with ethylenediamine (EDA), and forming a Janus dendrimer by synthesizing a second dendron on the primary core. The hydrophobized dendrimer includes a core containing a disulfide bond.

### CROSS-REFERENCE TO RELATED APPLICATION

This application claims the benefit of priority from pending U.S. Provisional Patent Application Ser. No. 63/077,712, filed on Sep. 14, 2020, and entitled “Synthesis of Janus Dendrimers,” which is incorporated herein by reference in its entirety.

### TECHNICAL FIELD

The present disclosure generally relates to branched polymeric molecules, particularly to dendrimers, and more particularly to a method for synthesis of Janus dendrimers.

### BACKGROUND

Dendrimers are among the most popular multifaceted systems that have attracted the scientific community's attention in the last three decades due to their unique structure and properties, such as high-density terminal groups and monodispersity small size, ordered shape, and three-dimensional branch structure. However, classic dendrimers have only one type of terminal group, limiting their applications for simultaneous loading of different drugs or simultaneous loading of the drug and the gene. The possibility of designing dendrimers' structures paves the way to synthesize more complicated dendrimers with various peripheral groups on their surfaces. As a result, dendrimers with different peripheral groups in different parts of the surface can be obtained by synthesis of block co-dendrimers, di-block co-dendrimers, di-block dendrimers, surface-block dendrimers, and asymmetrical dendrimers known as Janus dendrimers.

A Janus dendrimer is a combination of two dissimilar dendrons combined with a core. Nowadays, three main methods based on divergent and convergent approaches have been proposed to synthesize the Janus dendrimers. The easiest method to synthesize Janus dendrimers is a reaction of two dendrons that have complementary factors as the core. Another method consists of a dendron-controlled reaction with a multi-functional core and a second dendron reaction with the core's remaining functional groups. The third method is rarely used and involves using a focal point to grow new branches dendrons with the divergent process.

However, conventional methods proposed for Janus dendrimers' synthesis do not produce pure Janus dendrimers and produce dendrimers with similar end-groups as an impurity, which leads to an uncontrolled synthesis of the Janus dendrimers. Hence, there is a need for an efficient and simple method for synthesizing Janus dendrimers with high purity and without producing conventional dendrimers.

### SUMMARY

This summary is intended to provide an overview of the subject matter of the present disclosure and is not intended to identify essential elements or key elements of the subject matter, nor is it intended to be used to determine the scope of the claimed implementations. The proper scope of the present disclosure may be ascertained from the claims set forth below in view of the detailed description below and the drawings.

In one general aspect, the present disclosure describes an exemplary method for synthesizing Janus dendrimers. Exemplary method may include synthesizing a hydrophobized dendrimer by reacting a dendrimer with a carboxylic acid, forming a first dendron with a thiol group by splitting the hydrophobized dendrimer through breaking a disulfide bond of the core into thiol groups, forming a reactive dendron by reacting the thiol group of the first dendron with methyl acrylate and a radical initiator, synthesizing a primary core by reacting the reactive dendron with ethylenediamine (EDA), and forming a Janus dendrimer by synthesizing a second dendron on the primary core.

In an exemplary embodiment, the hydrophobized dendrimer may include a core containing a disulfide bond. In an exemplary embodiment, reacting the dendrimer with the carboxylic acid may include reacting the dendrimer with the carboxylic acid at a molar ratio of the carboxylic acid to the dendrimer between about 10 and about 15 at a temperature between about 25° C. and about 60° C. for a time period between about 4 hours and about 72 hours. In an exemplary embodiment, reacting the dendrimer with the carboxylic acid may include reacting the dendrimer with the carboxylic acid with an alkyl group. In an exemplary embodiment, the alkyl group may include at least one of methyl, ethyl, propyl, and butyl.

In an exemplary embodiment, reacting the dendrimer with the carboxylic acid may include reacting a dendrimer with at least one of an amine terminal group, an epoxide terminal group, a hydroxyl terminal group, and a carboxyl terminal group with the carboxylic acid. In an exemplary embodiment, reacting the dendrimer with the carboxylic acid may include reacting at least one of a poly(propylene imine) (PPI) dendrimer, a poly(amidoamine) (PAMAM) dendrimer, a poly(L-lysine) (PLL) dendrimer, a phosphine dendrimer, a polyethyleneimine (PEI) dendrimer, a poly(amidoamine-organosilicon) (PAMAMOS) dendrimer with the carboxylic acid.

In an exemplary embodiment, splitting the dendrimer through breaking the disulfide bond of the core into the thiol groups may include reacting the hydrophobized dendrimer with a reducing agent at a temperature between about 25° C. and about 40° C. for a time period between about 2 hours and about 72 hours. In an exemplary embodiment, reacting the hydrophobized dendrimer with the reducing agent may include reacting the hydrophobized dendrimer with the reducing agent at a molar ratio of the hydrophobized dendrimer to the reducing agent between about 1 and about 2.

In an exemplary embodiment, reacting the hydrophobized dendrimer with the reducing agent may include reacting the hydrophobized dendrimer with at least one of dithiothreitol (DTT), bis(2-mercaptoethyl)sulfone (BMS), meso-2,5-dimercapto-N, N, N′, N′-tetramethyladipamide (DTA), and dimethyl-N, N′-bis (mercaptoacetyl) hydrazine (DMH). In an exemplary embodiment, reacting the thiol group of the first dendron with the methyl acrylate and the radical initiator may include reacting the thiol group of the first dendron with the methyl acrylate and the radical initiator at a molar ratio of the methyl acrylate:the radical initiator:thiol group of the first dendron between about 5:1:1 and about 10:2:2.

In an exemplary embodiment, reacting the thiol group of the first dendron with the methyl acrylate and the radical initiator may include reacting the thiol group of the first dendron with the methyl acrylate and the radical initiator at a temperature between about 60° C. and about 90° C. under nitrogen atmosphere for a time period between about 3 hours and about 6 hours. In an exemplary embodiment, reacting the thiol group of the first dendron with the methyl acrylate and the radical initiator may include reacting the thiol group of the first dendron with the methyl acrylate and at least one of azobisisobutyronitrile (AIBN), dimethylphenylphosphine (DMPP), methyldiphenylphosphine (MDPP), and trimethylamine (TEA).

In an exemplary embodiment, reacting the reactive dendron with the EDA may include reacting the reactive dendron with the EDA at a molar ratio of the EDA to the reactive dendron between about 2 and about 10 at a temperature between about 20° C. and about 40° C. for a time period between about 4 days and about 6 days. In an exemplary embodiment, synthesizing the second dendron on the primary core may include synthesizing the second dendron on primary core using at least one of a click chemistry mechanism, an esterification reaction, and a Michael addition/amidation reaction.

In an exemplary embodiment, synthesizing the second dendron on the primary core may include synthesizing a half-generation of the second dendron by reacting the primary core with methyl acrylate and synthesizing a first generation of the second dendron by reacting the half-generation of the second dendron with the EDA. In an exemplary embodiment, reacting the primary core with the methyl acrylate may include reacting the primary core with the methyl acrylate at a molar ratio of the methyl acrylate to the primary core between about 4 and about 8 at a temperature between about 20° C. and about 40° C. for a time period between about 1 day and about 3 days.

In an exemplary embodiment, synthesizing the second dendron on the primary core may include synthesizing the second dendron with at least one of an amine terminal group, an epoxide terminal group, a hydroxyl terminal group, and a carboxyl terminal group on the primary core. In an exemplary embodiment, synthesizing the second dendron on the primary core may include synthesizing at least one of a poly(propylene imine) (PPI) dendron, a poly(amidoamine) (PAMAM) dendron, a poly(L-lysine) (PLL) dendron, a phosphine dendron, a polyethyleneimine (PEI) dendron, a poly(amidoamine-organosilicon) (PAMAMOS) dendron on the primary core. In an exemplary embodiment, forming the Janus dendrimer may include forming the Janus dendrimer with a dispersity (B) between about 1 and about 1.15. In an exemplary embodiment, the core containing the disulfide bond may include at least one of cystamine, N, N′-bis(acryloyl)cystamine, 3,3′-dithiodipropionic acid, cystaminium dichloride, and 2-hydroxyethyl disulfide.

### BRIEF DESCRIPTION OF THE DRAWINGS

The drawing figures depict one or more implementations in accordance with the present teachings, by way of example only, not by way of limitation. In the figures, like reference numerals refer to the same or similar elements.

FIG. 1A illustrates a flowchart of an exemplary method for synthesizing Janus dendrimers, consistent with one or more exemplary embodiments of the present disclosure.

FIG. 1B illustrates a flowchart of an exemplary implementation for synthesizing a second dendron on a thiol group of a first dendron, consistent with one or more exemplary embodiments of the present disclosure.

FIG. 2A illustrates a schematic representation of an exemplary implementation for synthesizing a hydrophobized dendrimer containing a core with a disulfide bond by reacting a dendrimer with a carboxylic acid, consistent with one or more exemplary embodiments of the present disclosure.

FIG. 2B illustrates a schematic representation of an exemplary implementation for forming a first dendron with a thiol group by splitting the hydrophobized dendrimer through breaking a disulfide bond of the core into thiol groups, consistent with one or more exemplary embodiments of the present disclosure.

FIG. 2C illustrates a schematic representation of an exemplary implementation for forming a reactive dendron by reacting the thiol group of the first dendron with methyl acrylate and a radical initiator, consistent with one or more exemplary embodiments of the present disclosure.

FIG. 2D illustrates a schematic representation of an exemplary implementation for synthesizing a second dendron by amidation and Michael addition of the reactive dendron, consistent with one or more exemplary embodiments of the present disclosure.

FIG. 3A illustrates chromatograms of gel permeation chromatography (GPC) of hydrophobized PPI dendrimers (G5C) and hydrophobized PPI dendrons (G5C-CS), consistent with one or more exemplary embodiments of the present disclosure.

FIG. 3B illustrates GPC chromatograms of Janus dendrimers G5C-G′0.5, G5C-G′1.5, G5C-G′2.5, and G5C-G′3.5, consistent with one or more exemplary embodiments of the present disclosure.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

The following detailed description is presented to enable a person skilled in the art to make and use the methods and devices disclosed in exemplary embodiments of the present disclosure. For purposes of explanation, specific nomenclature is set forth to provide a thorough understanding of the present disclosure. However, it will be apparent to one skilled in the art that these specific details are not required to practice the disclosed exemplary embodiments. Descriptions of specific exemplary embodiments are provided only as representative examples. Various modifications to the exemplary implementations will be readily apparent to one skilled in the art, and the general principles defined herein may be applied to other implementations and applications without departing from the scope of the present disclosure. The present disclosure is not intended to be limited to the implementations shown but is to be accorded the widest possible scope consistent with the principles and features disclosed herein.

The present disclosure describes simple exemplary methods for synthesizing Janus dendrimers with a high purity, which is considered a purity above 95%. Exemplary methods may produce exemplary Janus dendrimers without producing dendrimers with similar end groups as a by-product. Exemplary methods may be used to synthesize exemplary Janus dendrimers by symmetric structure scission of dendrimers into first dendrons and divergent growth of second dendrons on the first dendrons. In an exemplary embodiment, exemplary Janus dendrimers may include two different parts with different backbones and different peripheral groups. In an exemplary embodiment, exemplary Janus dendrimers may include amphiphilic Janus dendrimers containing hydrophobic and hydrophilic parts.

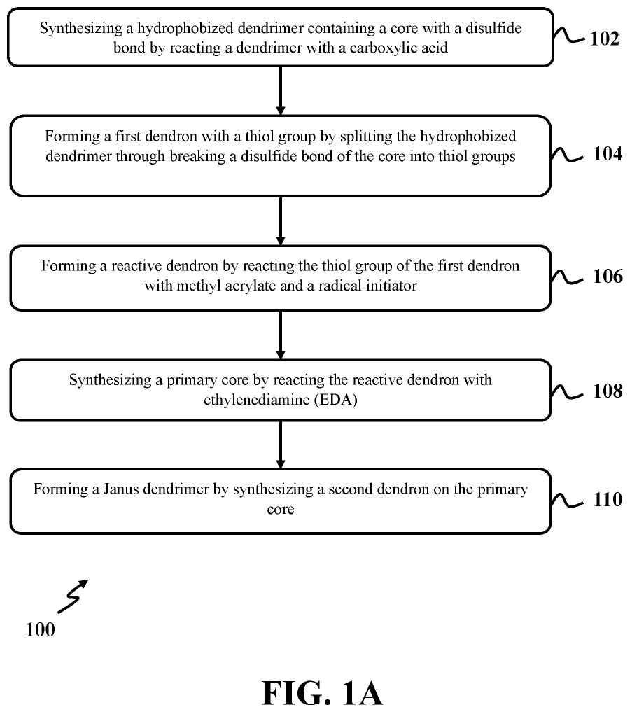

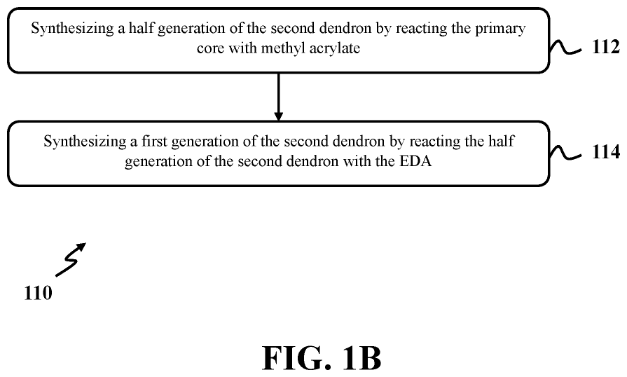

FIG. 1A illustrates a flowchart of an exemplary method 100 for synthesizing exemplary Janus dendrimers, consistent with one or more exemplary embodiments of the present disclosure. Referring to FIG. 1, an exemplary method 100 may include synthesizing a hydrophobized dendrimer containing a core with a disulfide bond by reacting a dendrimer with a carboxylic acid (step 102), forming a first dendron with a thiol group by splitting the hydrophobized dendrimer through breaking a disulfide bond of the core into thiol groups (step 104), forming a reactive dendron by reacting the thiol group of the first dendron with methyl acrylate and a radical initiator (step 106), synthesizing a primary core by reacting the reactive dendron with ethylenediamine (EDA) (step 108), and forming a Janus dendrimer by synthesizing a second dendron on the primary core (step 110).

In further detail with respect to step 102, in an exemplary embodiment, synthesizing a hydrophobized dendrimer may include reacting a dendrimer with a carboxylic acid. In an exemplary embodiment, reacting the dendrimer with the carboxylic acid may hydrophobize the dendrimer by adding amide groups on the dendrimer's surface. In an exemplary embodiment, reacting the dendrimer with the carboxylic acid may include reacting the dendrimer with the carboxylic acid containing an alkyl group. In an exemplary embodiment, the alkyl group may include at least one of methyl, ethyl, propyl, and butyl. In an exemplary embodiment, the carboxylic acid may include at least one of propionic acid, formic acid, butyric acid, acetic acid, valeric acid, arachidic acid, nonadecylic acid, stearic acid, margaric acid, palmitic acid, pentadecylic acid, myristic acid, tridecylic acid, lauric acid, undecylic acid, capric acid, pelargonic acid, caprylic acid, enanthic acid, and caproic acid.

In an exemplary embodiment, reacting the dendrimer with the carboxylic acid may include reacting the dendrimer with the carboxylic acid at a molar ratio of the carboxylic acid to the dendrimer between about 10 and about 15. In an exemplary embodiment, reacting the dendrimer with the carboxylic acid may include reacting the dendrimer with the carboxylic acid at a temperature between about 25° C. and about 60° C. for a time period between about 4 hours and about 72 hours. In an exemplary embodiment, reacting the dendrimer with the carboxylic acid may include reacting the dendrimer with the carboxylic acid in the presence of an amidation catalyst including at least one of N,N′-dicyclohexylcarbodiimide (DCC), 4-(dimethylamino)pyridine (DMAP), N,N′-dicyclohexylurea, N,N′-dicyclohexylcarbodiimide, and dicyclohexylcarbodiimide.

In an exemplary embodiment, the hydrophobized dendrimer may include a core with a disulfide bond. In an exemplary embodiment, the core may include at least one of cystamine, N, N′-bis(acryloyl)cystamine, 3,3′-dithiodipropionic acid, cystaminium dichloride, and 2-hydroxyethyl disulfide. In an exemplary embodiment, reacting the dendrimer with the carboxylic acid may include reacting a dendrimer with at least one of an amine terminal group, an epoxide terminal group, a hydroxyl terminal group, and a carboxyl terminal group with the carboxylic acid. In an exemplary embodiment, reacting the dendrimer with the carboxylic acid may include reacting at least one of a poly(propylene imine) (PPI) dendrimer, a poly(amidoamine) (PAMAM) dendrimer, a poly(L-lysine) (PLL) dendrimer, a phosphine dendrimer, a polyethyleneimine (PEI) dendrimer, a poly(amidoamine-organosilicon) (PAMAMOS) dendrimer with the carboxylic acid. In an exemplary embodiment, reacting the dendrimer with a generation between zero (0) and ten (10) with the carboxylic acid.

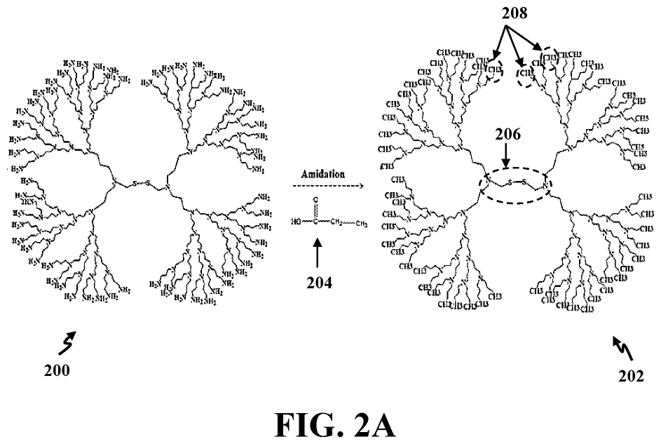

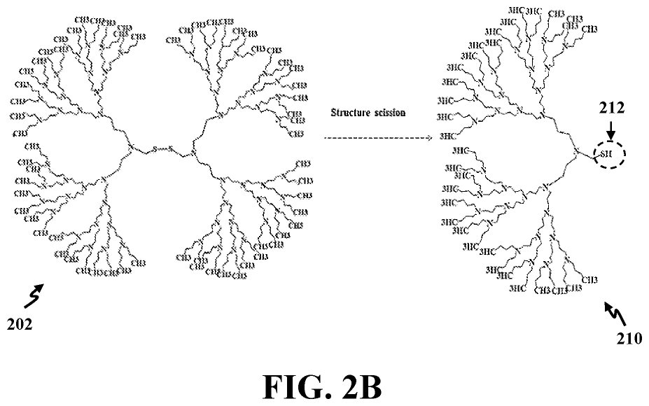

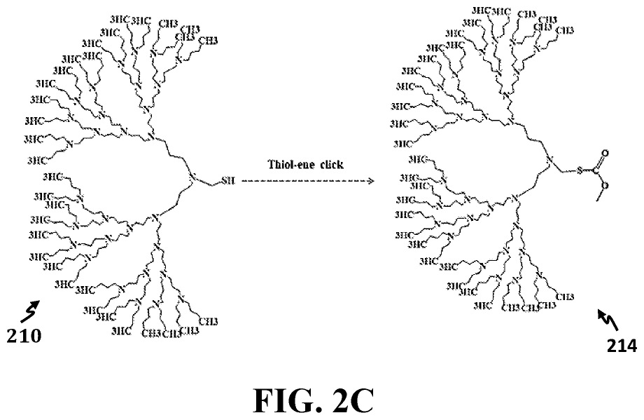

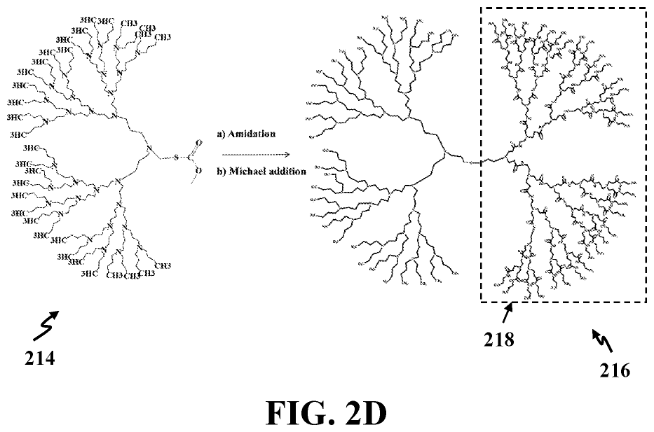

FIG. 2A illustrates a schematic representation of an exemplary implementation of step 102 for synthesizing a hydrophobized dendrimer containing a core with a disulfide bond by reacting a dendrimer with a carboxylic acid, consistent with one or more exemplary embodiments of the present disclosure. Referring to FIG. 2A, a hydrophobized PPI dendrimer 202 may be synthesized by reacting a PPI dendrimer 200 with propionic acid 204. Exemplary hydrophobized PPI dendrimer 202 may include a cystamine core 206 as a core with a disulfide bond. Exemplary hydrophobized PPI dendrimer 202 may include amide terminal groups 208. In an exemplary embodiment, PPI dendrimer 200 may include five (5) generations.

In further detail with respect to step 104, in an exemplary embodiment, forming a first dendron with a thiol group may include splitting the hydrophobized dendrimer by breaking a disulfide bond core into thiol groups. In an exemplary embodiment, reacting the hydrophobized dendrimer with the reducing agent may lead to symmetrical structure scission of the hydrophobized dendrimer into first dendrons. In an exemplary embodiment, breaking the disulfide bond of the core into the thiol groups may include reacting the hydrophobized dendrimer with a reducing agent.

In an exemplary embodiment, reacting the hydrophobized dendrimer with the reducing agent may include chemically reducing the disulfide bond into two thiol groups. In an exemplary embodiment, reacting the hydrophobized dendrimer with the reducing agent may include reacting the hydrophobized dendrimer with the reducing agent at a temperature between about 25° C. and about 40° C. for a time period between about 2 hours and about 72 hours. In an exemplary embodiment, reacting the hydrophobized dendrimer with the reducing agent may include reacting the hydrophobized dendrimer with the reducing agent at a molar ratio of the hydrophobized dendrimer to the reducing agent between about 1 and about 2.

In an exemplary embodiment, reacting the hydrophobized dendrimer with the reducing agent may include reacting the hydrophobized dendrimer with at least one of dithiothreitol (DTT), bis(2-mercaptoethyl)sulfone (BMS), meso-2,5-dimercapto-N, N, N′, N′-tetramethyladipamide (DTA), and dimethyl-N, N′-bis (mercaptoacetyl) hydrazine (DMH). FIG. 2B illustrates a schematic representation of an exemplary implementation of step 104 for forming a first dendron with a thiol group by splitting the hydrophobized dendrimer through breaking a disulfide bond of the core into thiol groups, consistent with one or more exemplary embodiments of the present disclosure. Referring to FIG. 2B, a hydrophobized PPI dendron 210 with a thiol group 212 may be obtained by splitting hydrophobized PPI dendrimer 202 using the DTT.

In further detail with respect to step 106, in an exemplary embodiment, forming a reactive dendron may include reacting the thiol group of the first dendron with methyl acrylate and a radical initiator. In an exemplary embodiment, reacting the thiol group of the first dendron with the methyl acrylate and the radical initiator may include reacting the thiol group of the first dendron with the methyl acrylate and the radical initiator at a molar ratio of the methyl acrylate:the radical initiator:thiol group of the first dendron between about 5:1:1 and about 10:2:2. In an exemplary embodiment, reacting the thiol group of the first dendron with the methyl acrylate and the radical initiator may include reacting the thiol group of the first dendron with the methyl acrylate and the radical initiator at a temperature between about 60° C. and about 90° C. under nitrogen atmosphere.

In an exemplary embodiment, reacting the thiol group of the first dendron with the methyl acrylate and the radical initiator may include reacting the thiol group of the first dendron with the methyl acrylate and the radical initiator for a time period between about 3 hours and about 6 hours. In an exemplary embodiment, reacting the thiol group of the first dendron with the methyl acrylate and the radical initiator may include reacting the thiol group of the first dendron with the methyl acrylate and at least one of azobisisobutyronitrile (AIBN), dimethylphenylphosphine (DMPP), methyldiphenylphosphine (MDPP), and trimethylamine (TEA). FIG. 2C illustrates a schematic representation of an exemplary implementation of step 106 for forming a reactive dendron by reacting the thiol group of the first dendron with methyl acrylate and a radical initiator, consistent with one or more exemplary embodiments of the present disclosure. Referring to FIG. 2C, a reactive dendron 214 may be formed through performing a thiol-ene click mechanism by reacting hydrophobized PPI dendron 210 with methyl acrylate and AIBN as the radical initiator.

In further detail with respect to step 108, in an exemplary embodiment, synthesizing a primary core may include reacting the reactive dendron with EDA. In an exemplary embodiment, reacting the reactive dendron with the EDA may include reacting the reactive dendron with the EDA at a molar ratio of the EDA to the reactive dendron between about 2 and about 10. In an exemplary embodiment, reacting the reactive dendron with the EDA may include reacting the reactive dendron with the EDA at a temperature between about 20° C. and about 40° C. In an exemplary embodiment, reacting the reactive dendron with the EDA may include reacting the reactive dendron with the EDA for a time period between about 4 days and about 6 days.

In further detail with respect to step 110, in an exemplary embodiment, synthesizing a second dendron on the primary core may include synthesizing the second dendron on the primary core using a divergent method. In an exemplary embodiment, synthesizing the second dendron on the primary core may include synthesizing the second dendron on the primary core using at least one of a click chemistry reaction, an esterification reaction, and a Michael addition/amidation reaction. FIG. 1B illustrates a flowchart of an exemplary implementation for synthesizing a second dendron on the primary core, consistent with one or more exemplary embodiments of the present disclosure. Referring to FIG. 1B, details of exemplary step 110 of method 100 may include synthesizing a half-generation of the second dendron by reacting the primary core with methyl acrylate (step 112) and synthesizing a first generation of the second dendron by reacting the half-generation of the second dendron with the EDA (step 114).

In an exemplary embodiment, synthesizing the second dendron on the primary core may include synthesizing the second dendron with at least one of an amine terminal group, an epoxide terminal group, a hydroxyl terminal group, and a carboxyl terminal group on the primary core. In an exemplary embodiment, synthesizing the second dendron on the primary core may include synthesizing at least one of a poly(propylene imine) (PPI) dendron, a poly(amidoamine) (PAMAM) dendron, a poly(L-lysine) (PLL) dendron, a phosphine dendron, a polyethyleneimine (PEI) dendron, a poly(amidoamine-organosilicon) (PAMAMOS) dendron on the primary core. In an exemplary embodiment, synthesizing the second dendron on the primary core may include synthesizing the second dendron with a generation number between zero (0) and ten (10) on the primary core.

In further detail with respect to step 112, in an exemplary embodiment, synthesizing a half-generation of the second dendron may include reacting the primary core with methyl acrylate. In an exemplary embodiment, reacting the primary core with the methyl acrylate may include reacting the primary core with the methyl acrylate with a molar ratio of the methyl acrylate to the primary core between about 4 and about 8. In an exemplary embodiment, reacting the primary core with the methyl acrylate may include reacting the primary core with the methyl acrylate at a temperature between about 20° C. and about 40° C. for a time period between about 1 day and about 3 days.

In further detail with respect to step 114, in an exemplary embodiment, synthesizing a first generation of the second dendron may include reacting the half-generation of the second dendron with the EDA. In an exemplary embodiment, reacting the half-generation of the second dendron with the EDA may include reacting the half-generation of the second dendron with the EDA at a molar ratio of the EDA to the half-generation of the second dendron between about 2 and about 16. In an exemplary embodiment, reacting the half-generation of the second dendron with the EDA may include reacting the half-generation of the second dendron with the EDA at a temperature between about 20° C. and about 40° C. In an exemplary embodiment, reacting the half-generation of the second dendron with the EDA may include reacting the half-generation of the second dendron with the EDA for a time period between about 4 days and about 6 days.

In an exemplary embodiment, synthesizing next generations of the second dendron may include repeating the amidation reaction and the Michael addition mechanism. In an exemplary embodiment, synthesizing next generations of the second dendron may include adding a generation to the second dendron. In an exemplary embodiment, adding a generation to the second dendron may include repeating two steps, including adding a half-generation to the second dendron by reacting the second dendron with methyl acrylate and synthesizing a complete generation on the second dendron by reacting the half-generation of the second dendron with the EDA. In an exemplary embodiment, synthesizing a next generation of the second dendron may require the methyl acrylate and the EDA with double amount than synthesizing the previous generation of the second dendron.

FIG. 2D illustrates a schematic representation of an exemplary implementation for synthesizing a second dendron by repeating amidation and Michael addition of the reactive dendron, consistent with one or more exemplary embodiments of the present disclosure. Referring to FIG. 2D, a PAMAM dendron with four generations 218 may be synthesized by repeating an amidation reaction followed by Michael addition of reactive dendron 214. A Janus dendrimer 216 may include hydrophobized PPI dendron with five generations and a hydrophilic PAMAM dendron with four generations. Exemplary Janus dendrimers, similar to Janus dendrimer 216, synthesized using exemplary method 100 of FIG. 1A may include dendrons with different functionality.

In an exemplary embodiment, two dendrons of each exemplary Janus dendrimer may join each other via a shared core. In an exemplary embodiment, exemplary Janus dendrimer may have a dispersity (Ð) between about 1 and about 1.15. In an exemplary embodiment, exemplary Janus dendrimers may be used for improving the solubility of hydrophobic drugs. In an exemplary embodiment, exemplary Janus dendrimers may have a molecular weight between about 1000 g/mol and about 20,000 g/mol. In an exemplary embodiment, exemplary Janus dendrimers may have a size between about 2 nm and about 30 nm.

### EXAMPLES

### Example 1: Synthesis of Exemplary Janus Dendrimers

In this example, exemplary Janus dendrimers containing a hydrophobized PPI dendron and a PAMAM dendron, similar to exemplary Janus dendrimer 216 of FIG. 2D was synthesized utilizing a process similar to exemplary method 100 as presented in FIG. 1. In the first step, similar to exemplary step 102, a PPI dendrimer with a cystamine core was hydrophobized by forming amide groups on a PPI dendrimer's surface by reacting the PPI dendrimer with propionic acid. At first, a solution of the PPI dendrimer with five generations and a cystamine core (GSA) with a concentration of about 28 mM was formed by dissolving the GSA in dry pyridine.

Afterward, a reaction mixture was formed by adding propionic acid to the solution of the GSA with a molar ratio of the propionic acid to the GSA of about 12.78. The reaction was carried out in the presence of DCC as a catalyst at room temperature for a time period of about 72 hours. The solvent was then removed using the rotary evaporator under vacuum, and the product was washed using tetrahydrofuran (THF). Finally, hydrophobized PPI dendrimer (G5C) was dried in a vacuum at a temperature of about 50° C. for a time period of about 24 hours.

In the next step, similar to exemplary step 104, the hydrophobized PPI dendrimer with the cystamine core participated in symmetric structure scission, resulting in hydrophobized PPI dendrons with thiol functional groups. At first, a solution of the G5C with a concentration of about 208 mM was formed by dissolving the G5C in methanol. The symmetric structure scission was conducted by adding DTT to the solution of the G5C at a molar ratio of about 1.4 (DTT:G5C) at room temperature for a time period of about 48 hours. Also, hydrophobized PPI dendrons with thiol functional groups (G5C-CS) as a product were washed by water and subjected to a vacuum at a temperature of about 50° C. for a time period of about 48 hours to remove unreacted DTT and oxidized DTT.

In the next step, similar to exemplary step 106, a PPI reactive dendron was obtained by performing a thiol-ene click reaction through reacting the hydrophobized PPI dendron with the thiol group with methyl acrylate and AIBN. At first, a dendron solution with a concentration of about 6 mM was formed by dissolving the hydrophobized PPI dendron with the thiol group in methanol. Afterward, methyl acrylate and AIBN were added to the dendron solution at a molar ratio of 10:1:1 (methyl acrylate:AIBN:thiol group of the hydrophobized PPI dendron). The thiol-ene click reaction was carried out under nitrogen at a temperature of about 80° C. for a time period of about 4 hours. The reactive PPI dendrons as the product were washed with double-distilled water to remove the unreactive materials. Finally, the reactive PPI dendrons were dried in a vacuum oven at a temperature of about 60° C. for a time period of about 72 hours.

In the next step, similar to exemplary step 108, a primary core was formed through amidation of the PPI reactive dendron by reacting the PPI reactive dendron with EDA. In the amidation reaction, a primary core of PAMAM dendron was formed by mixing a reactive PPI dendron solution with the EDA at a molar ratio of about 5. After stirring at room temperature for 5 days, solvent and unreacted monomers were removed by rotary evaporator under vacuum. For complete purification, the dendrimers containing hydrophobized PPI dendrons and the primary core of PAMAM dendrons (G5C-G′0.0) as the product was subjected to a vacuum oven at a temperature of about 45° C. for a time period of about 48 hours.

In the next step, similar to exemplary step 110, a hydrophilic PAMAM dendron with four generations was synthesized on the primary core by iterative amidation reaction and Michael addition. At first, a G5C-G′0.0 dendrimer solution with a concentration of about 1.2 mM was formed by dissolving the dendrimer with the primary core (G5C-G′0.0) in methanol. The G5C-G′0.0 dendrimer solution was then mixed with methyl acrylate at a molar ratio of 5 (methyl acrylate:G5C-G′0.0 dendrimer) at room temperature for a time period of about 48 hours. Then, methanol and unreacted monomers were removed by a rotary evaporator and a vacuum oven at a temperature of about 45° C. for a time period of about 48 hours. The amidation reaction and Michael addition were repeated with increased amounts of methyl acrylate and EDA until the fourth generation of the PAMAM dendron was synthesized. The final product was named G5C-G′4.0 as the Janus dendrimer.

### Example 2: Characterization of Exemplary Janus Dendrimers

In this example, exemplary dendrimers and Janus dendrimers, produced in EXAMPLE 1 using a similar method described in method 100 of FIG. 1, were characterized regarding size, dispersity, and molecular weight using dynamic light scattering (DLS) and gel permeation chromatography (GPC). Also, reaction yield of each step was determined.

TABLE 1
Reaction yield, DLS, and GPC data for the synthesis of
Janus dendrimers

| | DLS | | GPC | | |
|---|---|---|---|---|---|
| Sample | d_{z} (nm) | Ð | Mₙ ( g/mol) | Ð | Yield |
| G5A | 4.2 | 0.055 | — | — | ~99 |
| G5C | 22.0 | 0.002 | 233700 | 1.05 | ~96 |
| G5C-CS | 4.5 | 0.041 | 85500 | 1.12 | ~89 |
| G5C-G′0.0 | 5.2 | 0.05 | | | ~97 |
| G5C-G′0.5 | — | — | 90000 | 1.05 | ~99 |
| G5C-G′1.0 | 6.1 | 0.02 | | | ~94 |
| G5C-G′1.5 | — | — | 126000 | 1.07 | ~93 |
| G5C-G′2.0 | 10.5 | 0.03 | | | ~95 |
| G5C-G′2.5 | — | — | 194000 | 1.07 | ~95 |
| G5C-G′3.0 | 16.8 | 0.04 | | | ~96 |
| G5C-G′3.5 | — | — | 300000 | 1.08 | ~91 |
| G5C-G′4.0 | 28.2 | 0.04 | | | ~92 |

Referring to TABLE. 1, comparison the DLS results of G5A and G5C indicates that hydrophobization of the G5A dendrimer using propionic acid increased the size of the dendrimers. Also, comparison the DLS and GPC results of the G5C-CS shows a significant reduction compared to the results of the G5C, which proves the structure scission mechanism of the G5C dendrimer into two dendrons (G5C-CS). According to the DLS and GPC results, increasing the generations of the PAMAM dendron of the Janus dendrimers lead to increasing the size of the Janus dendrimers. All of the synthesized Janus dendrimers showed narrow dispersity (D). To further confirm the successful generation growth of PAMAM dendron and prove the narrow size distribution, GPC was used to determine the molecular weight and molecular weight distribution of G5C-G′0.5, G5C-G′1.5, G5C-G′2.5, and G5C-G′3.5.

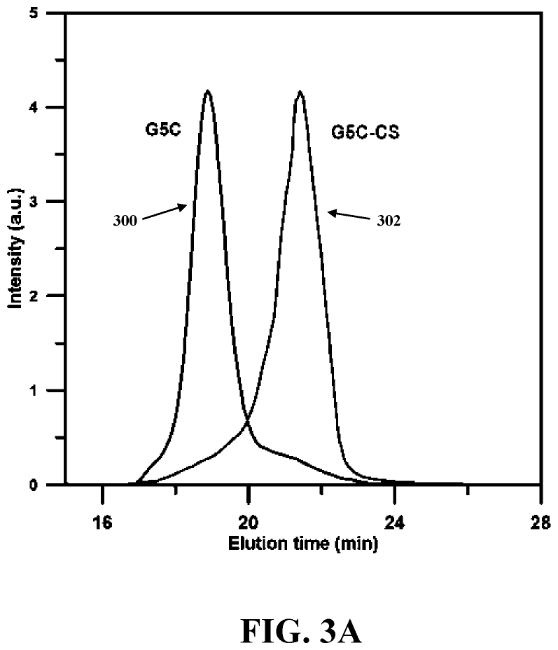

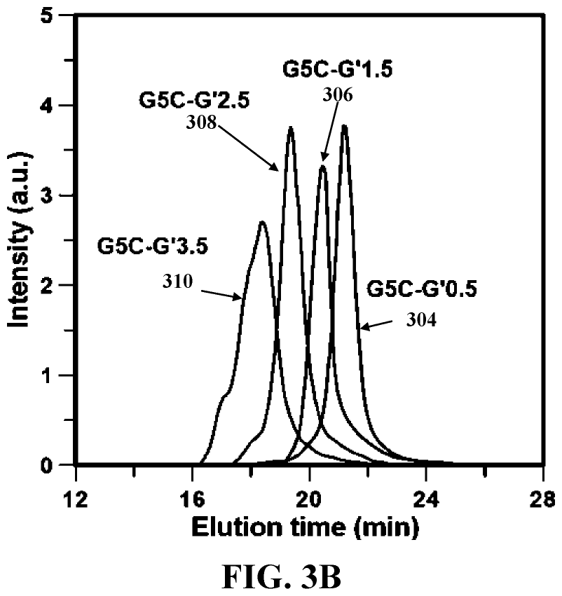

FIG. 3A illustrates chromatograms of gel permeation chromatography (GPC) of hydrophobized PPI dendrimers (G5C) 300 and hydrophobized PPI dendrons (G5C-CS) 302, consistent with one or more exemplary embodiments of the present disclosure. Referring to FIG. 3A, the GPC trace of G5C-CS 302 showed a higher elution time compared to G5C 300 dendrimer due to its smaller size while its dispersity (D) was obtained 1.12 which was still narrow. FIG. 3B illustrates GPC chromatograms of Janus dendrimers G5C-G′0.5 304, G5C-G′1.5 306, G5C-G′2.5 308, and G5C-G′3.5 310, consistent with one or more exemplary embodiments of the present disclosure. Referring to FIG. 3B, lower generation number of Janus dendrimers leads to smaller size and higher elution time of the Janus dendrimers. Also, narrow dispersity of the Janus dendrimers indicates the uniform structures of the Janus dendrimers with different generations.

### Example 3: Application of Exemplary Janus Dendrimers for Improving Drug Solubility

While Janus dendrimers have hydrophilic and hydrophobic ends and numerous internal cavities, they may be used for improving solubility of hydrophobic drugs. In this example, G5C-G′4.0 as exemplary Janus dendrimers, synthesized in EXAMPLE 1 utilizing a process similar to exemplary method 100 as presented in FIG. 1, were used to improve the solubility of tetracycline and dexamethasone. In this experiment, the solubility of drugs was determined by measuring the absorbance of samples using turbidimetry at a wavelength of about 600 nm utilizing ultraviolet-visible-near-IR spectroscopy (UV-VIS-NIR) spectrophotometer.

At first, tetracycline and dexamethasone solubility in an aqueous medium at a pH level of about 7.4 was about 0.3 mg/ml and about 0.1 mg/ml, respectively. Tetracycline and dexamethasone were encapsulated in the Janus dendrimers with three and four generations to evaluate Janus dendrimers' effect on hydrophobic drugs' solubility. The hydrophobic drugs in the Janus dendrimers were encapsulated by mixing solutions of the Janus dendrimers with tetracycline and dexamethasone at saturation concentrations at room temperature for a time period of about 15 minutes. The Janus dendrimers' solutions at concentrations of about 0.1 mM and about 0.3 mM were prepared by dissolving the Janus dendrimers in distilled water.

TABLE 2
Solubility of dexamethasone and tetracycline in water in the
presence of different concentrations of Janus dendrimers

| | Dendrimer | | |
|---|---|---|---|
| | concentration | Tetracycline | Dexamethasone |
| Dendrimer | (mM) | (mg/mL) | (mg/mL) |
| G5C-G′3.0 | 0.1 | 6.8 ± 0.3 | 1.4 ± 0.1 |
| | 0.3 | 12.0 ± 0.6 | 1.6 ± 0.1 |
| G5C-G′4.0 | 0.1 | 14.1 ± 0.6 | 1.8 ± 0.2 |
| | 0.3 | 23.4 ± 0.8 | 2.0 ± 0.1 |
| G5A | 0.1 | 0.43 ± 0.04 | 0.22 ± 0.02 |
| | 0.3 | 0.51 ± 0.02 | 1.03 ± 0.07 |
| G4.0 | 0.1 | 5.06 ± 0.12 | 0.11 ± 0.01 |
| | 0.3 | 9.53 ± 0.21 | 0.12 ± 0.01 |

Referring to TABLE. 2, the solubility of dexamethasone and tetracycline as the hydrophobic drugs in water was increased by increasing concentration and generation of the Janus dendrimer. Results showed that Janus dendrimers improved the solubility of hydrophobic drugs in water due to their amphiphilic nature. The hydrophobic dendron encapsulated the drug through hydrophobic interactions within the internal cavities of the dendron. Also, due to the presence of hydrophilic end groups, hydrophilic dendron interacted with water solvent via hydrogen bonding. Additionally, Janus dendrimers improved the solubility of hydrophobic drugs much better at higher generations and concentrations due to the presence of more terminal groups. Also, drug interacts with the tertiary amines through hydrogen bonding. Since the amine terminal groups are positively charged, they may electrostatically interact with negatively charged drugs.

While the foregoing has described what may be considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such away. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations. This is for purposes of streamlining the disclosure and is not to be interpreted as reflecting an intention that the claimed implementations require more features than are expressly recited in each claim. Rather, as the following claims reflect, the inventive subject matter lies in less than all features of a single disclosed implementation. Thus, the following claims are hereby incorporated into the Detailed Description, with each claim standing on its own as a separately claimed subject matter.

While various implementations have been described, the description is intended to be exemplary, rather than limiting and it will be apparent to those of ordinary skill in the art that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in the light of the attached claims and their equivalents. Also, various modifications and changes may be made within the scope of the attached claims.

What is claimed is:

1. A method for synthesizing Janus dendrimers, the method comprising:
synthesizing a hydrophobized poly(propylene imine) (PPI) dendrimer by reacting a PPI dendrimer with propionic acid, the hydrophobized PPI dendrimer comprising a core containing a disulfide bond;
forming a hydrophobized PPI dendron with a thiol group by splitting the hydrophobized PPI dendrimer through breaking a disulfide bond of the core into thiol groups;
forming a reactive dendron by reacting the thiol group of the hydrophobized PPI dendron with methyl acrylate and a radical initiator;
synthesizing a primary core by reacting the reactive dendron with ethylenediamine (EDA); and
forming a Janus dendrimer by synthesizing a polyamidoamine (PAMAM) dendron on the primary core, wherein synthesizing the PAMAM dendron on the primary core comprises:
synthesizing a half-generation of the PAMAM dendron by reacting the primary core with methyl acrylate; and
synthesizing a first generation of the PAMAM dendron by reacting the half-generation of the PAMAM dendron with the EDA.

2. A method for synthesizing Janus dendrimers, the method comprising:
synthesizing a hydrophobized dendrimer by reacting a dendrimer with a carboxylic acid, the hydrophobized dendrimer comprising a core containing a disulfide bond;
forming a first dendron with a thiol group by splitting the hydrophobized dendrimer through breaking a disulfide bond of the core into thiol groups;
forming a reactive dendron by reacting the thiol group of the first dendron with methyl acrylate and a radical initiator;
synthesizing a primary core by reacting the reactive dendron with ethylenediamine (EDA); and
forming a Janus dendrimer by synthesizing a second dendron on the primary core.

3. The method of claim 2, wherein reacting the dendrimer with the carboxylic acid comprises reacting the dendrimer with the carboxylic acid at a molar ratio of the carboxylic acid to the dendrimer between 10 and 15 at a temperature between 25° C. and 60° C. for a time period between 4 hours and 72 hours.

4. The method of claim 2, wherein reacting the dendrimer with the carboxylic acid comprises reacting the dendrimer with a carboxylic acid containing an alkyl group, the alkyl group comprising at least one of methyl, ethyl, propyl, and butyl.

5. The method of claim 2, wherein reacting the dendrimer with the carboxylic acid comprises reacting a dendrimer with at least one of an amine terminal group, an epoxide terminal group, a hydroxyl terminal group, and a carboxyl terminal group with the carboxylic acid.

6. The method of claim 2, wherein reacting the dendrimer with the carboxylic acid comprises reacting at least one of a poly(propylene imine) (PPI) dendrimer, a poly(amidoamine) (PAMAM) dendrimer, a poly(L-lysine) (PLL) dendrimer, a phosphine dendrimer, a polyethyleneimine (PEI) dendrimer, a poly(amidoamine-organosilicon) (PAMAMOS) dendrimer with the carboxylic acid.

7. The method of claim 2, wherein splitting the dendrimer through breaking the disulfide bond of the core into the thiol groups comprises reacting the hydrophobized dendrimer with a reducing agent at a temperature between 25° C. and 40° C. for a time period between 2 hours and 72 hours.

8. The method of claim 7, wherein reacting the hydrophobized dendrimer with the reducing agent comprises reacting the hydrophobized dendrimer with the reducing agent at a molar ratio of the hydrophobized dendrimer to the reducing agent between 1 and 2.

9. The method of claim 7, wherein reacting the hydrophobized dendrimer with the reducing agent comprises reacting the hydrophobized dendrimer with at least one of dithiothreitol (DTT), bis(2-mercaptoethyl)sulfone (BMS), meso-2,5-dimercapto-N, N, N′, N′-tetramethyladipamide (DTA), and dimethyl-N, N′-bis (mercaptoacetyl) hydrazine (DMH).

10. The method of claim 2, wherein reacting the thiol group of the first dendron with the methyl acrylate and the radical initiator comprises reacting the thiol group of the first dendron with the methyl acrylate and the radical initiator at a molar ratio of the methyl acrylate:the radical initiator:thiol group of the first dendron between 5:1:1 and 10:2:2.

11. The method of claim 2, wherein reacting the thiol group of the first dendron with the methyl acrylate and the radical initiator comprises reacting the thiol group of the first dendron with the methyl acrylate and the radical initiator at a temperature between 60° C. and 90° C. under nitrogen atmosphere for a time period between 3 hours and 6 hours.

12. The method of claim 2, wherein reacting the thiol group of the first dendron with the methyl acrylate and the radical initiator comprises reacting the thiol group of the first dendron with the methyl acrylate and at least one of azobisisobutyronitrile (AIBN), dimethylphenylphosphine (DMPP), methyldiphenylphosphine (MDPP), and trimethylamine (TEA).

13. The method of claim 2, wherein reacting the reactive dendron with the EDA comprises reacting the reactive dendron with the EDA at a molar ratio of the EDA to the reactive dendron between 2 and 10 at a temperature between 20° C. and 40° C. for a time period between 4 days and 6 days.

14. The method of claim 2, wherein synthesizing the second dendron on the primary core comprises synthesizing the second dendron on the primary core using at least one of a click chemistry mechanism, an esterification reaction, and a Michael addition/amidation reaction.

15. The method of claim 2, wherein synthesizing the second dendron on the primary core comprises:
synthesizing a half-generation of the second dendron by reacting the primary core with methyl acrylate; and
synthesizing a first generation of the second dendron by reacting the half-generation of the second dendron with the EDA.

16. The method of claim 15, wherein reacting the primary core with the methyl acrylate comprises reacting the primary core with the methyl acrylate at a molar ratio of the methyl acrylate to the primary core between 4 and 8 at a temperature between 20° C. and 40° C. for a time period between 1 day and 3 days.

17. The method of claim 2, wherein synthesizing the second dendron on the primary core comprises synthesizing the second dendron with at least one of an amine terminal group, an epoxide terminal group, a hydroxyl terminal group, and a carboxyl terminal group on the primary core.

18. The method of claim 2, wherein synthesizing the second dendron on the primary core comprises synthesizing at least one of a poly(propylene imine) (PPI) dendron, a poly(amidoamine) (PAMAM) dendron, a poly(L-lysine) (PLL) dendron, a phosphine dendron, a polyethyleneimine (PEI) dendron, a poly(amidoamine-organosilicon) (PAMAMOS) dendron on the primary core.

19. The method of claim 2, wherein forming the Janus dendrimer comprises forming the Janus dendrimer with a dispersity (Ð) between 1 and 1.15.

20. The method of claim 2, wherein the core containing the disulfide bond comprises at least one of cystamine, N, N′-bis(acryloyl)cystamine, 3,3′-dithiodipropionic acid, cystaminium dichloride, and 2-hydroxyethyl disulfide.
